(19) United States
(12) Patent Application Publication
(10) Pub. No.: US 2007/0018783 A1
(43) Pub. Date: Jan. 25, 2007

(54) Digital addressable lighting interface translation method

(75) Inventor: Robert A. Erhardt, Schaumburg, IL (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,540

(22) PCT Filed: Sep. 2, 2004
(86) PCT No.: PCT/IB04/51675

§ 371 Date: Mar. 3, 2006

Related U.S. Application Data
(60) Provisional application No. 60/500,073, filed on Sep. 4, 2003.

(51) Int. Cl. G05B 23/02

(52) U.S. Cl. 340/3.5

(57) ABSTRACT

A lighting system having multiple network levels implements various addresses schemes to communicate messages among various devices. A master controller (10) or a slave translator (21) transmits a master message (MM) to a slave device (30, 31) at a lower network level, wherein the master message (MM) includes an address associated with that particular lower network level and assigned to that particular slave device (30, 31). In the case where the slave device is a slave translator (21, 31), the slave translator (21, 31) will translate the master message (MM) into a translated message (TM) and transmit the translated message (TM) to a slave device (30, 40) at a lower network level, wherein the translated message (TM) includes an address associated with that particular lower network and assigned to slave device (30, 40).

The present invention generally relates to lighting control systems. The present invention specifically relates to Digital Addressable Lighting Interface (“DALI”) lighting control systems capable of controlling more than 64 addressed DALI lighting devices.

The DALI protocol is a known method whereby electronic ballasts, controllers and sensors belonging to the system in a lighting network are controlled via digital signals. Each system component has its own device-specific address, and this makes it possible to implement individual device control from a central computer. This capability allows for the lighting scenes to be controlled by the central computer, wherein several lamps within a specific area, such as a room or a landscape, are set to a specified light level designed to evoke a mood based on the quality of the illumination.

Research work connected to the DALI project began midway through the 1990s. However, the development of commercial applications got underway a little later, in the summer of 1998. At that time, DALI went under the name Digital Ballast Interface (“DBI”). An interface device (or ballast) is an electronic inductor enabling control of fluorescent lamps. The DALI standard has been the subject of R&D by numerous European ballast manufacturers such as Helvar, Huco, Philips, Osram, Tridonic, Trilux and Vossloh-Schwabe. The DALI standard is understood to have been added to the European electronic ballast standard “EN60929 Annex E”, and was first described in a draft amendment to International Electrotechnical Commission 929 (“IEC929”) entitled “Control by Digital Signals.” DALI is thus well known to those skilled in the art. Due to this standardization, different manufacturers' products can be interconnected provided that the manufacturers adhere to the DALI standard. The standard embodies individual ballast addressability, i.e., ballasts can be controlled individually when necessary. To date, ballasts connected to an analog 1-10 V DC low-voltage control bus have been subject to simultaneous control. Another advantage enabled by the DALI standard is the communication of the status of ballasts back to the lighting network's central control unit. This is especially useful in extensive installations where the light fixtures are widely distributed. The execution of commands compliant with the DALI standard and obtaining the status data presupposes intelligence on part of the ballast. This is generally provided by mounting a microprocessor within a DALI compliant ballast; the microprocessor also carries out other control tasks. Alternatively, two microprocessors can be utilized, one to interpret and service the DALI communications, and the other to provide the lamp control and diagnostics. The first products based upon the DALI technology became commercially available at the end of 1999.

The word ‘digital’ is a term which has become familiar to us all in the course of this decade in connection with the control technology built into domestic appliances as well as into industrial processes. Now, digital control is becoming increasingly common in the lighting industry as a result of the new DALI standard.

DALI messages comply with the Bi-Phase, or Manchester, coding scheme, in which the bit values ‘1’ and ‘0’ are each presented as two different voltage levels so that the change-over from the logic level ‘LOW’ to ‘HIGH’ (i.e., a rising pulse) corresponds to bit value ‘1’, and the change-over from the logic level ‘HIGH’ to ‘LOW’ (i.e., a falling pulse) corresponds to the bit value ‘0’. The coding scheme includes error detection and enables power supply to the control units even when there are no messages being transmitted or when the same bit value is repeated several times in succession. The bus's forward frame (used in communications from the central control unit to the local ballast) is comprised of 1 START bit, 8 address bits, 8 data/command bits, and 2 STOP bits, for a total of 19 bits. The backward frame (from the local ballast back to the central control unit) is comprised of 1 START bit, 8 data bits and 2 STOP bits, for a total of 11 bits. The specified baud rate is 2400.

DALI messages consist of an address part and a command part. The address part determines which DALI module the message is intended for. All the modules execute commands with ‘broadcast’ addresses. Sixty-four unique addresses are available plus sixteen group addresses. A particular module can belong to more than one group at one time. Commands can be made to individual addresses or group addresses and lighting scenes can be defined involving individual and/or group addresses.

The light level is defined in DALI messages using an 8-bit number, resulting in 128 total lighting levels. The value ‘0’ (zero), i.e., binary 0000 0000, means that the lamp is not lit. The remaining 127 levels correspond to the various dimming levels available. The DALI standard determines the light levels so that they comply with the logarithmic regulation curve in which case the human eye observes that the light changes in a linear fashion. All DALI ballasts and controllers adhere to the same logarithmic curve irrespective of their absolute minimum level. The DALI standard determines the light levels over a range of 0.1% to 100%. Level 1 in the DALI standard, i.e., binary 0000 0001, corresponds to a light level of 0.1%.

Examples of DALI messages in the form of commands include “Go to light level xx”, “Go to minimum level”, “Set value xx as regulation speed”, “Go to level compliant with situation xx”, and “Turn lamp off”. Examples of DALI messages in the form of queries include “What light level are you on?” and “What is your status?”.

The idea concerning the DALI protocol emerged when the leading manufacturers of ballasts for fluorescent lamps collaborated in the development of a protocol with the leading principle of bringing the advantages of digital control to be within the reach of as many users as possible. Furthermore, the purpose was to support the idea of “open architecture” so that any manufacturer's devices could be interconnected in a system.

In addition to control, the digital protocol enables feedback information to be obtained from the lighting fixture as to its adjustment level and the condition of the lamp and its ballast.

Examples of typical applications for systems using the DALI protocol are office and conference facilities, classrooms and facilities requiring flexibility in lighting adjustment DALI technology enables cost-effective implementation of lighting control of both smart individual lighting fixtures as well as of numerous segments connected to the automation bus of a building.

The lighting-control segment based on the DALI technology consists of maximum 64 individual addresses, which are interconnected by a paired cable. What is desired is a DALI system, which would increase the number of unique address beyond the 64 unique addresses available currently available. This would be useful to provide DALI control for buildings with more than 64 ballasts.

One form of the present invention is a method of communicating messages within a lighting system having multiple network levels.

In a first embodiment, a master controller transmits a master message to a slave translator at a first network level, wherein the master message includes a first address associated with the first network level and assigned to the slave translator. The slave translator translates the master message into translated message and transmits the translated message to a slave device at a second network level, wherein the translated message includes a second address associated with the second network level and assigned to the slave device.

In a second embodiment, a first slave translator transmits a master message to a second slave translator at a first network level, wherein the master message includes a first address associated with the first network level and assigned to the second slave translator. The second slave translator translates the master message into translated message and transmits the translated message to a slave device at a second network level, wherein the translated message includes a second address associated with the second network level and assigned to the slave device.

In a third embodiment, a slave translator transmits a master message to a lighting device at a first network level, wherein the master message includes an address associated with the first network level and assigned to the slave device. The slave device transmits a first slave message responsive to the master message to the slave translator at a second network level. The slave translator transmits a second slave message based on the first slave message to a master controller at a third network level.

In a fourth embodiment, a first slave translator transmits a master message to lighting device at a first network level, wherein the master message includes an address associated with the first network level and assigned to the slave device. The slave device transmits a first slave message responsive to the master message to the first slave translator at a second network level. The first slave translator transmits a second slave message based on the first slave message to a second translator at a third network level.

In a fifth embodiment, a slave translator transmits a master/translated message to a slave device at a first network level, wherein the master/translated message includes a first address associated with the first network level and assigned to the slave device. A master controller subsequently transmits a second master message to the slave translator at a second network level, wherein the second master message includes a second address associated with the second network level and assigned to the slave translator. The slave translator transmits a slave message to the master controller, wherein the slave message is based on the master/translated message and responsive to the second master message.

In a sixth embodiment, a first slave translator transmits a master/translated message to a slave device at a first network level, wherein the master/translated message includes a first address associated with the first network level and assigned to the slave device. A second slave translator subsequently transmits a second master message to the first slave translator at a second network level, wherein the second master message includes a second address associated with the second network level and assigned to the first slave translator. The first slave translator transmits a slave message based on the master/translated message and responsive to the second master message to the second slave translator.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

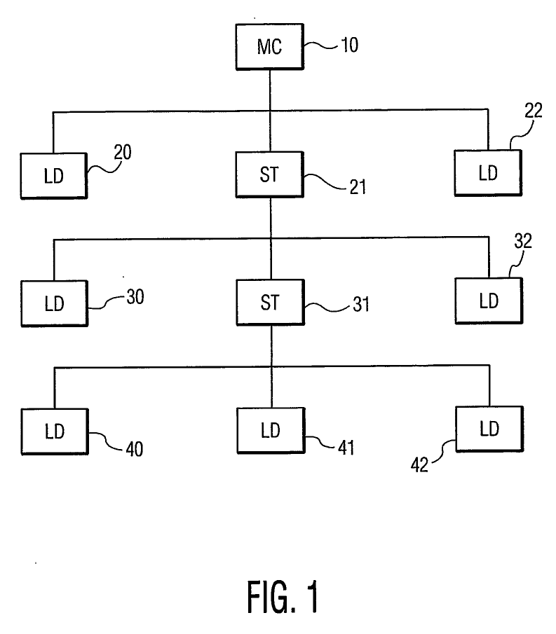

FIG. 1 illustrates a first embodiment of a lighting system in accordance with the present invention;

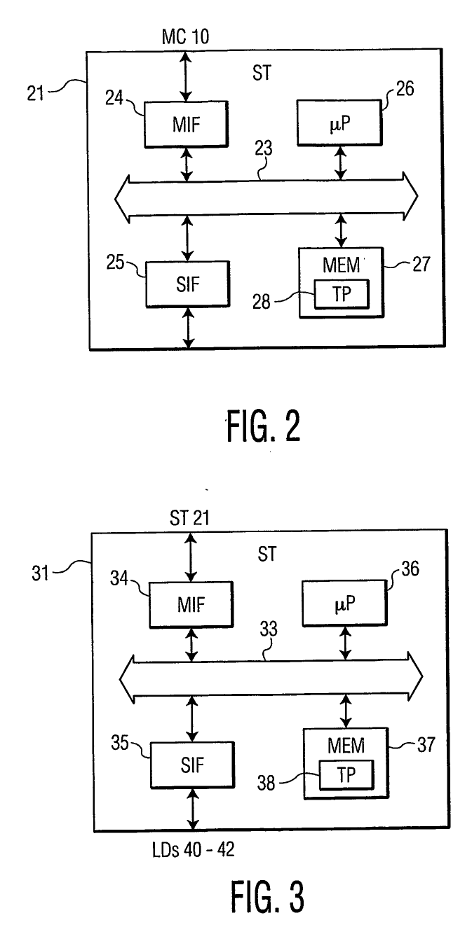

FIG. 2 illustrates one embodiment in accordance with the present invention of a slave translator at a second network level as illustrated in FIG. 1;

FIG. 3 illustrates one embodiment in accordance with the present invention of a slave translator at a third network level as illustrated in FIG. 1;

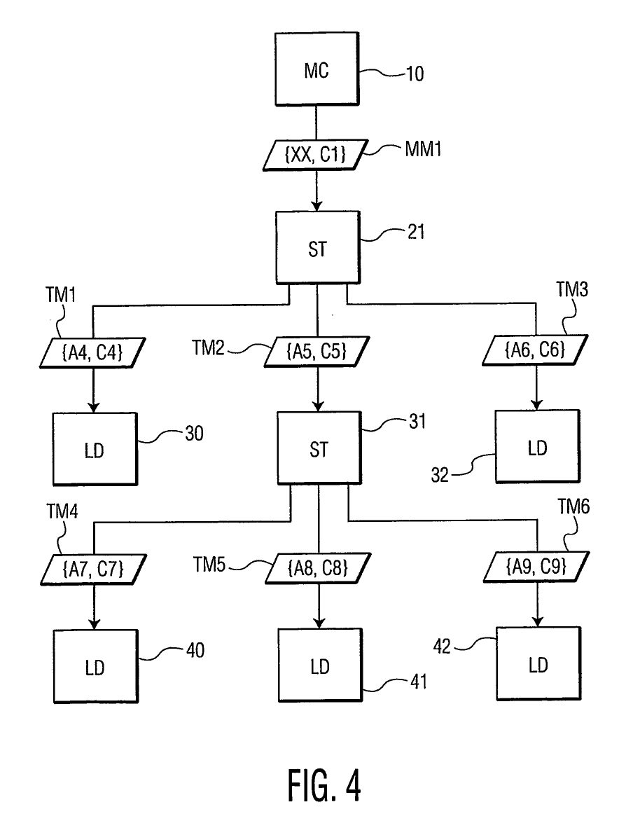

FIG. 4 illustrates a first exemplary transmission of various master and translated messages within the lighting system illustrated in FIG. 1 based on a command translation mode;

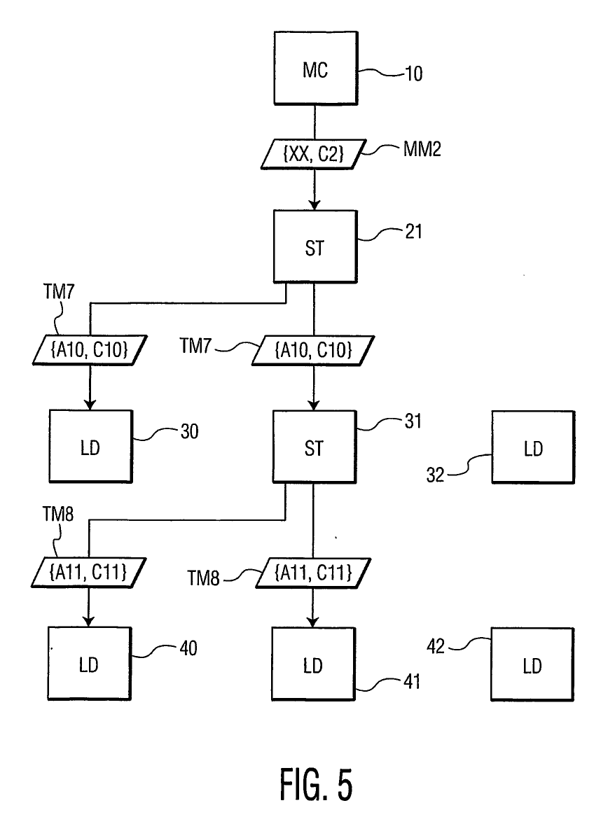

FIG. 5 illustrates a second exemplary transmission of various master and translated messages within the lighting system illustrated in FIG. 1 based on a command translation mode;

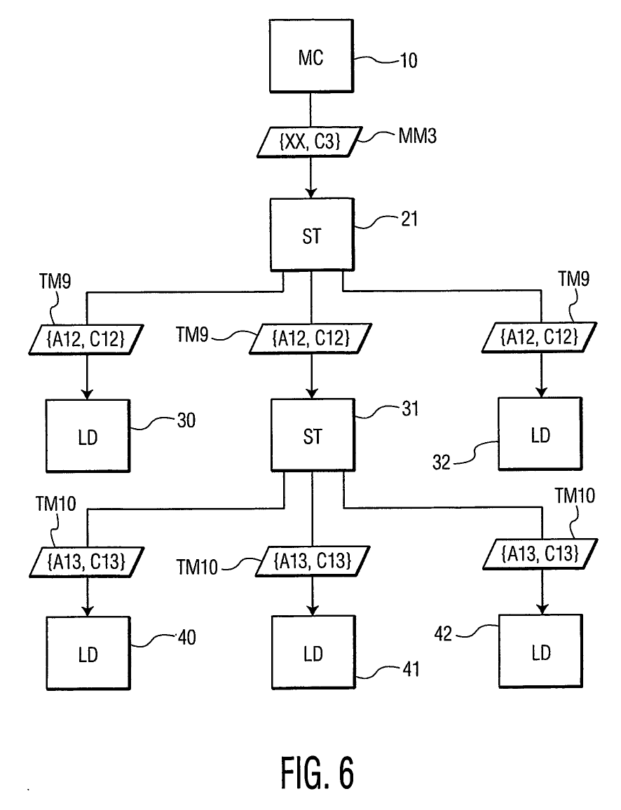

FIG. 6 illustrates a third exemplary transmission of various master and translated messages within the lighting system illustrated in FIG. 1 based on a command translation mode;

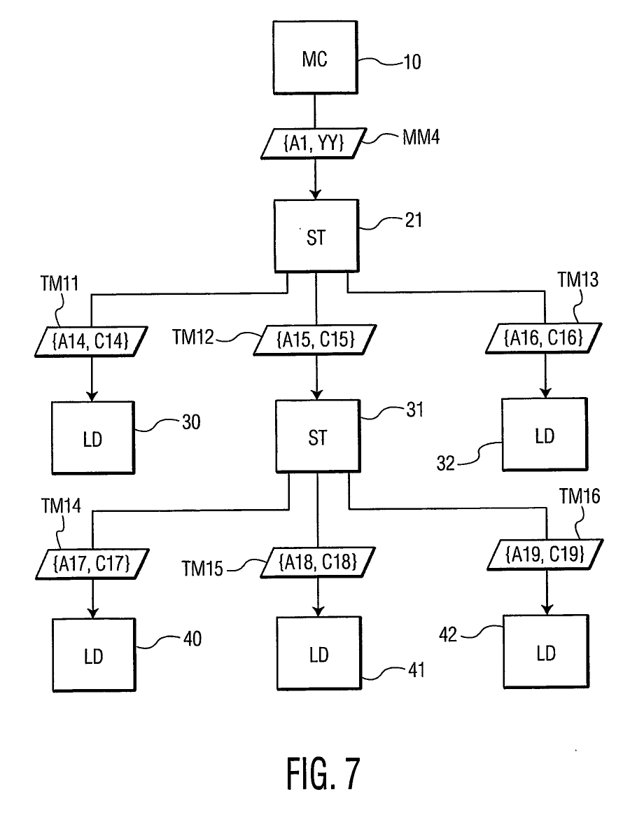

FIG. 7 illustrates a first exemplary transmission of various master and translated messages within the lighting system illustrated in FIG. 1 based on an address translation mode;

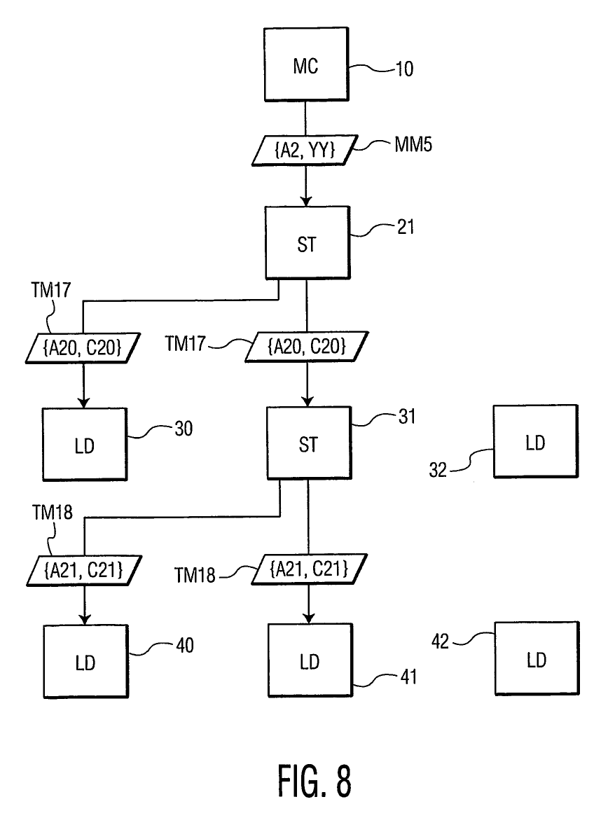

FIG. 8 illustrates a second exemplary transmission of various master and translated messages within the lighting system illustrated in FIG. 1 based on an address translation mode;

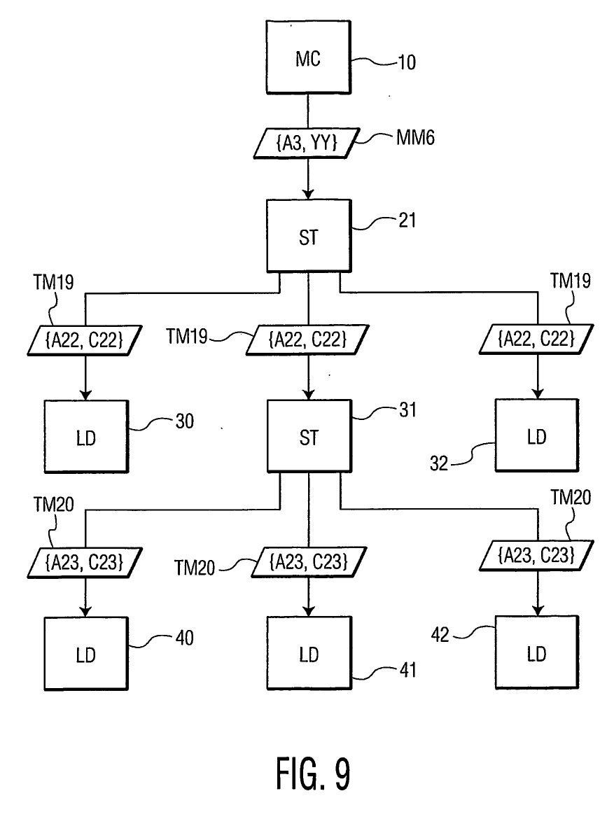

FIG. 9 illustrates a third exemplary transmission of various master and translated messages within the lighting system illustrated in FIG. 1 based on an address command translation mode;

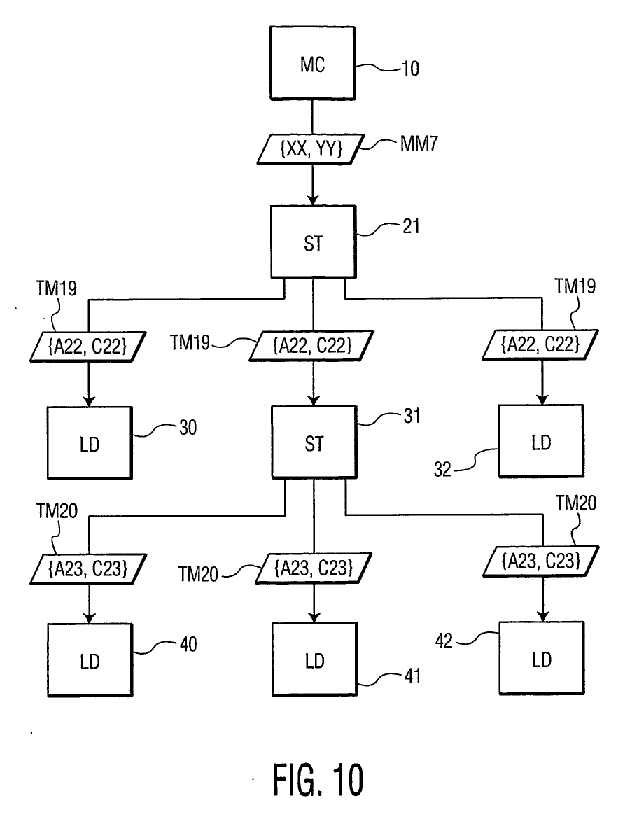

FIG. 10 illustrates an exemplary transmission of various master and translated messages within the lighting system illustrated in FIG. 1 based on a default translation mode;

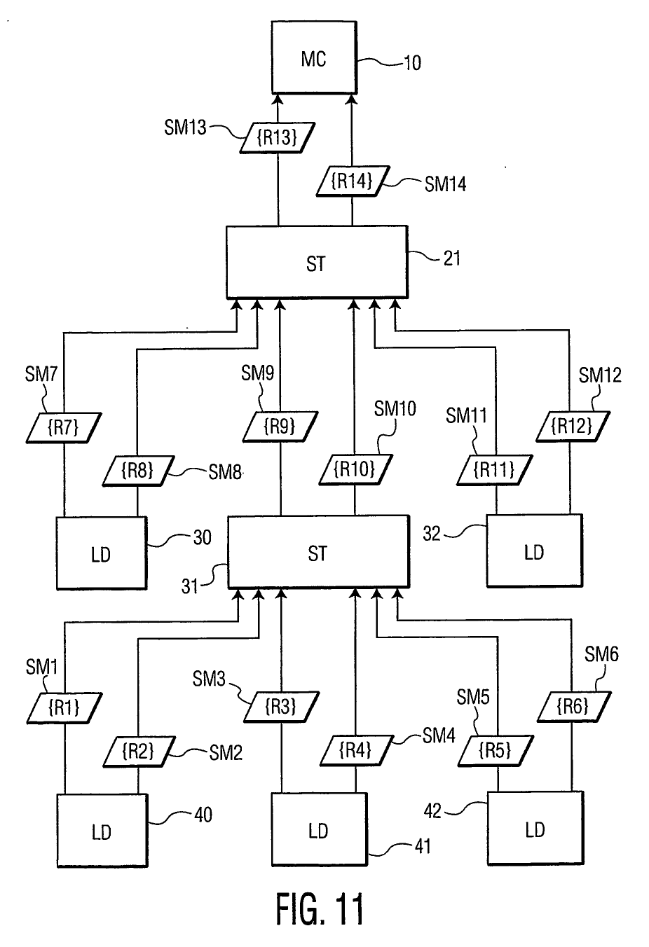

FIG. 11 illustrates a first exemplary transmission of various slave messages within the lighting system illustrated in FIG. 1;

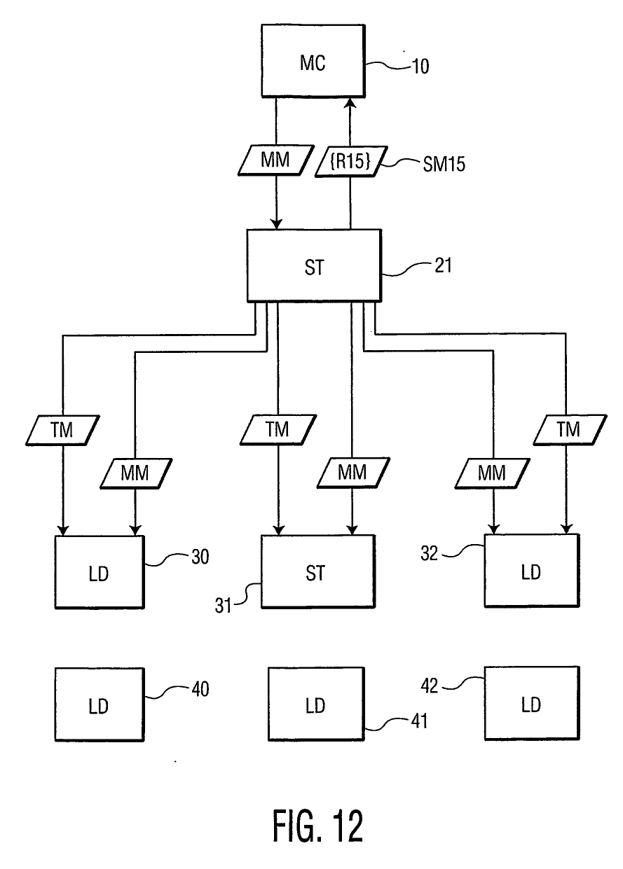

FIG. 12 illustrates a first exemplary transmission of various master and slave messages within the lighting system illustrated in FIG. 1;

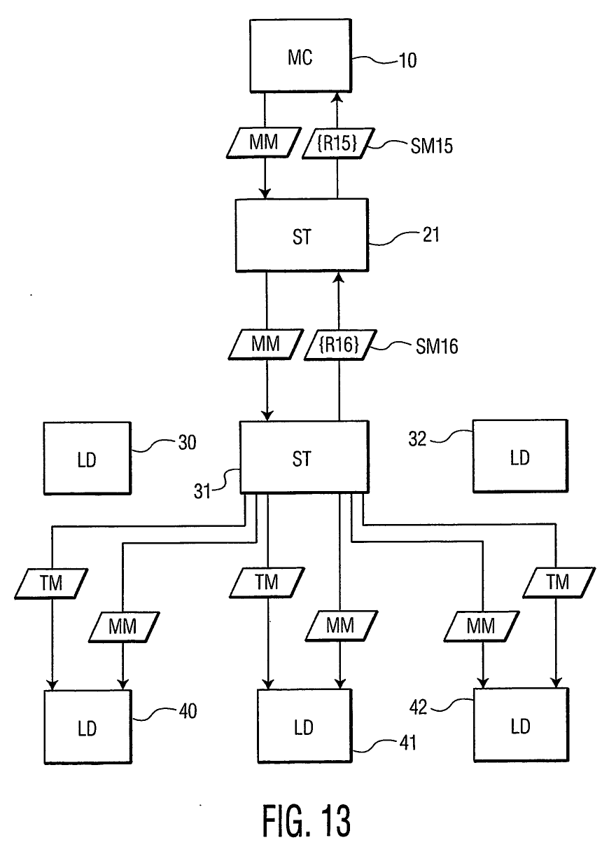

FIG. 13 illustrates a second exemplary transmission of various master and slave messages within the lighting system illustrated in FIG. 1;

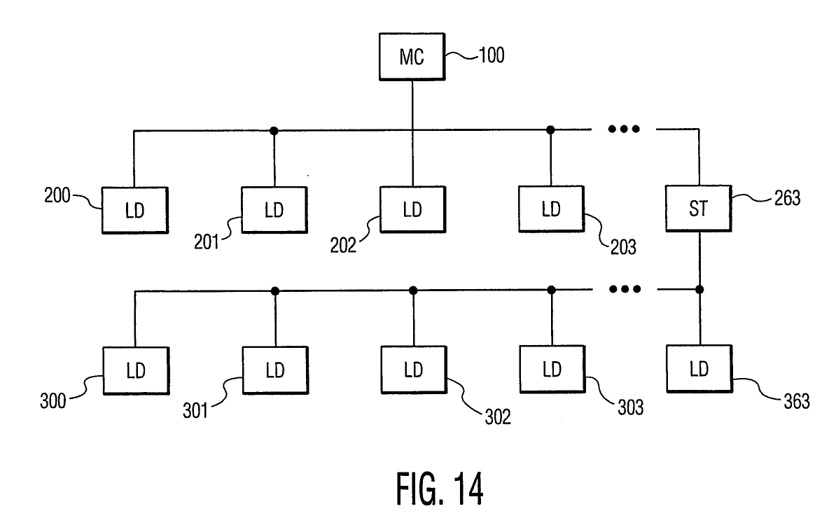

FIG. 14 illustrates a second embodiment of a lighting system in accordance with the present invention;

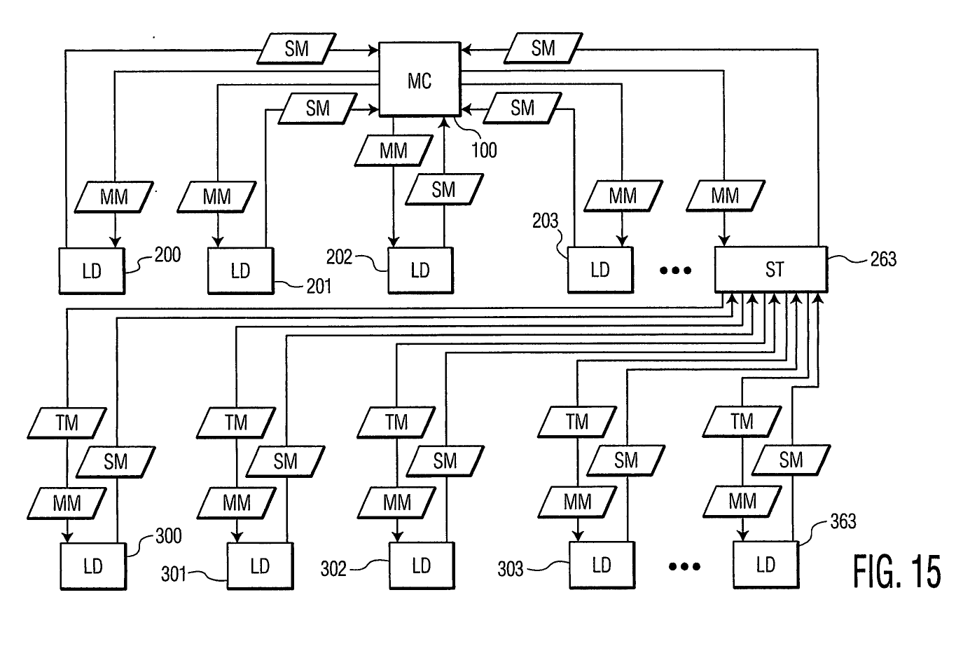

FIG. 15 illustrates a transmission of various messages within the lighting system illustrated in FIG. 14;

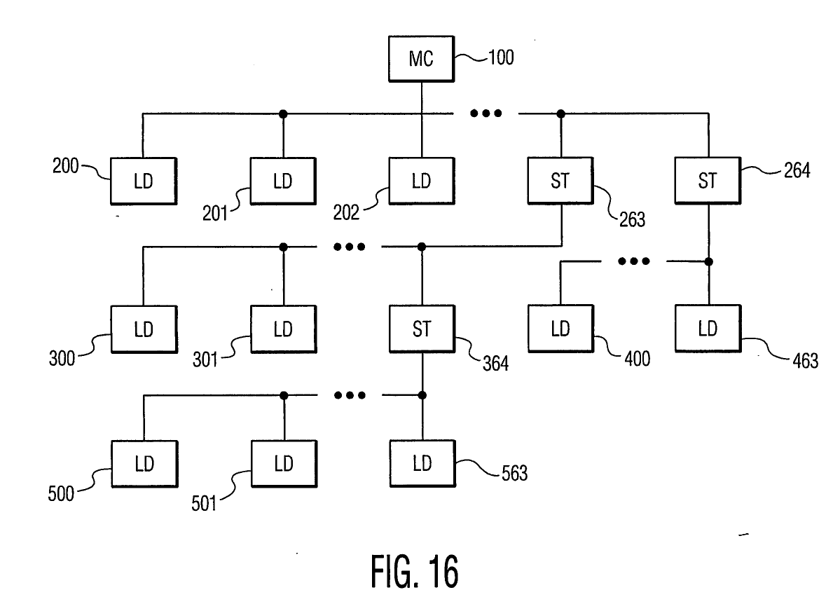

FIG. 16 illustrates a third embodiment of a lighting system in accordance with the present invention;

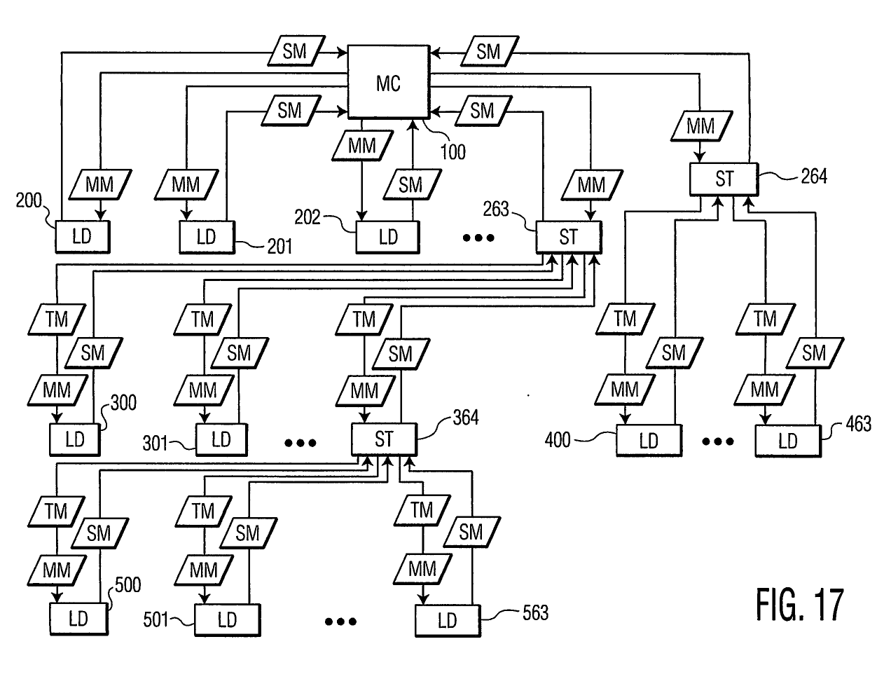

FIG. 17 illustrates a transmission of various messages within the lighting system illustrated in FIG. 16; and

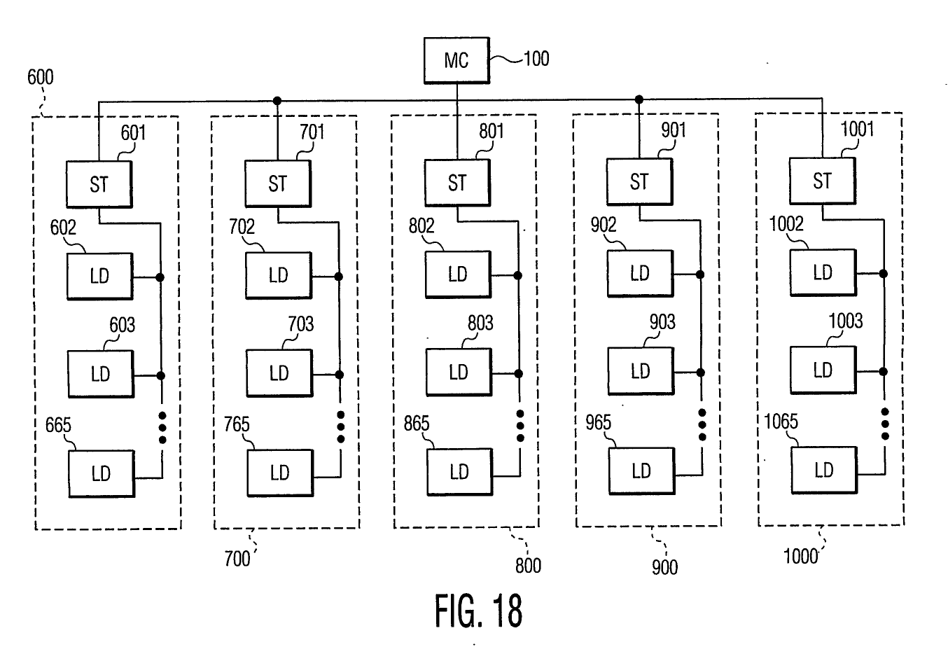

FIG. 18 illustrates a fourth embodiment of the lighting system in accordance with the present invention.

A lighting system as illustrated in FIG. 1 employs a conventional master controller (“MC”) 10 at a top network level. At one intermediate network level, the system employs a pair of conventional lighting devices (“LD”) 20 and 22, and a unique slave translator (“ST”) 21, all conventionally connected to master controller 10. At another intermediate network level, a pair of conventional lighting devices (“LD”) 30 and 32, and a unique slave translator (“ST”) 31, all conventionally connected to slave translator 21. At a bottom network level, three (3) conventional lighting devices (“LD”) 40-42 are conventionally connected to slave translator 31.

Master controller 10 is a conventional electronic module structurally configured to (1) generate and transmit master messages to lighting devices 20 and 22, and slave translator 21, and (2) receive and interpret slave messages from lighting devices 20 and 22, and slave translator 21. Master controller 10 preferably utilizes the DALI protocol in generating and transmitting the master messages, and in receiving and interpreting slave messages. Accordingly, master controller 20 implements the DALI address scheme (i.e., individual addresses, group addresses, and broadcast addresses) and the DALI command scheme (i.e., instructions and queries).

Lighting devices 20 and 22 are conventional electronic modules structurally configured to (1) receive and interpret master messages from master controller 10, and (2) respond when appropriate with a generation and transmission of a slave message to master controller 10. Lighting devices 20 and 22 preferably utilize the DALI protocol in receiving and interpreting master messages, and in generating and transmitting slave messages.

Slave translator 21 is an electronic module structurally configured to (1) receive and translate a master message from master controller 10 into one or more translated messages, (2) transmit the translated message(s) to lighting devices 30 and 32, and slave translator 31, (3) transmit master messages to lighting devices 30 and 32, and slave translator 31 when appropriate, (4) receive and interpret slave messages from lighting devices 30 and 32, and slave translator 31, and (5) generate and transmit slave messages when appropriate to master controller 10. Slave translator 21 preferably utilizes the DALI protocol in generating and transmitting the master/translated/slave messages, and in receiving and interpreting slave messages. Accordingly, slave translator 21 implements the DALI address scheme (i.e., individual addresses, group addresses, and broadcast addresses) and the DALI command scheme (i.e., instructions and queries).

Lighting devices 30 and 32 are conventional electronic modules structurally configured to (1) receive and interpret master messages from slave translator 21, and (2) respond when appropriate with a generation and transmission of a slave message to slave translator 21. Lighting devices 30 and 32 preferably utilize the DALI protocol in receiving and interpreting master messages, and in generating and transmitting slave messages.

Slave translator 31 is an electronic module structurally configured to (1) receive and translate a master message from slave translator 21 into one or more translated messages, (2) transmit the translated message(s) to lighting devices 40-42, (3) transmit master messages to lighting devices 40-42 when appropriate, (4) receive and interpret slave messages from lighting devices 30 and 32, and slave translator 31, and (5) generate and transmit slave messages when appropriate to slave translator 21. Slave translator 31 preferably utilizes the DALI protocol in generating and transmitting the master/translated/slave messages, and in receiving and interpreting slave messages. Accordingly, slave translator 31 implements the DALI address scheme (i.e., individual addresses, group addresses, and broadcast addresses) and the DALI command scheme (i.e., instructions and queries).

Lighting devices 40-42 are conventional electronic modules structurally configured to (1) receive and interpret master messages from slave translator 31, and (2) respond when appropriate with a generation and transmission of a slave message to slave translator 31. Lighting devices 40-42 preferably utilize the DALI protocol in receiving and interpreting master messages, and in generating and transmitting slave messages.

From the preceding description, it is to be appreciated that a novel feature of the lighting system illustrated in FIG. 1 is the master-slave relationship between master controller 10 and slave translator 21, the master-slave relationship between slave translator 21 and slave devices 30-32, and the master-slave relationship between slave translator 31 and lighting devices 40-42.

In practice, the structural configurations of master controller 10 and slave devices 20-42 are dependent upon commercial implementations of lighting system 10. In one embodiment, master controller 10, lighting device 20, lighting device 22, lighting device 30, lighting device 32, and lighting devices 40-42 employ conventional structural configurations for implementing the DALI protocol in performing their respective aforementioned functions, while slave translators 21 and 31 employ the structural configurations as illustrated in FIGS. 2 and 3, respectively, for implementing the DALI protocol in performing their respective aforementioned functions.

Slave translator 21 as illustrated in FIG. 2 employs a bus 23 for facilitating communications between a master interface (“MIF”) 24, a slave interface (“SIF”) 25, a microprocessor (“μP) 26, and a memory (“MEM”) 27. Interfaces 24 and 25 employ conventional structural configurations for communicating messages with master controller 10 and slave devices 30-32, respectively, in accordance with the DALI protocol. Memory (“MEM”) 27 employs a conventional structural configuration for storing a translation program (“TP”) 28 therein, and for reading and writing data associated with translation program 28., Microprocessor 26 employs a conventional structural configuration for executing a new and unique translation program (“TP”) 28 stored within memory 27.

Similarly, as illustrated in FIG. 3, slave translator 31 employs a bus 33 for facilitating communications between a master interface (“MIF”) 34, a slave interface (“SIF”) 35, a microprocessor (“μP) 36, and a memory (“MEM”) 37. Interfaces 34 and 35 employ conventional structural configurations for communicating messages with slave translator 21 and slave devices 40-42, respectively, in accordance with the DALI protocol. Memory (“MEM”) 37 employs a conventional structural configuration for storing a translation program (“TP”) 38 therein, and for reading and writing data associated with translation program 38. Microprocessor 36 employs a conventional structural configuration for executing a new and unique translation program (“TP”) 38 stored within memory 37.

Referring to FIGS. 2 and 3, translation programs 2 and 3 includes computer readable code for operating slave translators 21 and 31 in either a command translation mode, an address translation mode, a command-address translation mode, an address-command translation mode, and a default translation mode.

In the command translation mode, slave translator 21 utilizes a DALI command within a master message from master controller 10 as a basis for translating the master message into a translated message. Similarly, slave translator 31 utilizes a DALI command within a master message or a translated message from slave translator 21 as a basis for translating the master message or the translated message.

In the address translation mode, slave translator 21 utilizes a DALI address within a master message from master controller 10 as a basis for translating the master message into a translated message. Similarly, slave translator 31 utilizes a DALI address within a master message or a translated message from slave translator 21 as a basis for translating the master message or the translated message.

In the command-address translation mode, slave translator 21 sequentially utilizes a DALI command and a DALI address within a master message from master controller 10 as a basis for translating the master message into a translated message. Similarly, slave translator 31 sequentially utilizes a DALI command and a DALI address within a master message or a translated message from slave translator 21 as a basis for translating the master message or the translated message.

In the address-command translation mode, slave translator 21 sequentially utilizes a DALI address and a DALI command within a master message from master controller 10 as a basis for translating the master message into a translated message. Similarly, slave translator 31 sequentially utilizes a DALI address and a DALI command within a master message or a translated message from slave translator 21 as a basis for translating the master message or the translated message.

In default translation mode, slave translator 21 utilizes a receipt of a master message from master controller 10 as a basis for translating the master message into a translated message. Similarly, slave translator 31 utilizes a receipt of a master message or a translated message from slave translator 21 as a basis for translating the master message or the translated message.

To facilitate an understanding of the command translation mode, FIGS. 4-6 illustrate exemplary communications of various messages under the command translation mode in accordance with the following exemplary TABLE 1:

TABLE 1

| SLAVE | MASTER/TRANSLATED | TRANSLATED |
|---|---|---|
| TRANSLATOR | MESSAGE | MESSAGE |
| 21 | MM1: {XX*, C1} (FIG. 4) | TM1: {A4, C4} (FIG. 4) |
| | | TM2: {A5, C5} (FIG. 4) |
| | | TM3: {A6, C6} (FIG. 4) |
| | MM2: {XX*, C2} (FIG. 5) | TM7: {A10, C10) |
| | | (FIG. 5) |
| | MM3: {XX*, C3} (FIG. 6) | TM9: {A12, C12} |
| | | (FIG. 6) |
| 31 | TM2: {A5, C5} (FIG. 4) | TM4: {A7, C7} (FIG. 4) |
| (A5: Individual | | TM5: {A8, C8} (FIG. 4) |
| Address) | | TM6: {A9, C9} (FIG. 4) |
| (A10: Group | TM7: {A10, C10) (FIG. 5) | TM8: {A11, C11} |
| Address) | (FIG. 5) | |
| (A12: Broadcast | TM9: {A12, C12} (FIG. 6) | TM10: {A13, C13} |
| Address) | | (FIG. 6) |

XX* is either an individual DALI address, a group DALI address or a broadcast DALI address assigned to slave translator 21.

FIG. 4 illustrates a translation of command C1 by slave translator 21 into individually addressed translated messages TM1-TM3 in accordance with TABLE 1, and a transmission of individually addressed translated messages TM1-TM3 from slave translator 21 to slave devices 30-32. FIG. 4 further illustrates a translation of command C5 by slave translator 31 into individually addressed translated messages TM4-TM6 in accordance with TABLE 1, and a transmission of individually addressed translated messages TM4-TM6 from slave translator 31 to slave devices 40-42.

FIG. 5 illustrates a translation of command C2 by slave translator 21 into a group addressed translated message TM7 in accordance with TABLE 1, and a transmission of group addressed translated message TM7 from slave translator 21 to slave devices 30 and 31. FIG. 5 further illustrates a translation of command C10 by slave translator 31 into group addressed translated message TM8 in accordance with TABLE 1, and a transmission of group addressed translated message TM8 from slave translator 31 to slave devices 40 and 41.

FIG. 6 illustrates a translation of command C3 by slave translator 21 into a broadcast addressed translated message TM9 in accordance with TABLE 1, and a transmission of broadcast addressed translated message TM10 from slave translator 31 to slave devices 40-42. FIG. 6 further illustrates a translation of command C12 by slave translator 31 into broadcast addressed translated message TM10 in accordance with TABLE 1, and a transmission of group addressed translated message TM10 from slave translator 31 to slave devices 40-42.

To facilitate an understanding of the address translation mode, FIGS. 7-9 illustrate exemplary communications of various messages under the address translation mode in accordance with the following exemplary TABLE 2:

TABLE 2

| SLAVE | MASTER/TRANSLATED | TRANSLATED |
|---|---|---|
| TRANSLATOR | MESSAGE | MESSAGE |
| 21 | MM4: {A1, YY*} (FIG.7) | TM11: {A14, C14} (FIG. 7) |
| (A1: Individual Address) | | TM12: {A15, C15} (FIG. 7) |
| (A2: Group Address) | | TM13: {A16, C16} (FIG. 7) |
| (A3: Broadcast Address) | MM5: {A2, YY*} (FIG. 8) | TM17: {A20, C20) (FIG. 8) |
| | MM6: {A3, YY*} (FIG. 9) | TM19: {A22, C22} (FIG. 9) |
| 31 | TM12: {A15, C15} (FIG. 7) | TM14: {A17, C17} (FIG. 7) |
| (A15: Individual Address) | | TM15: {A18, C18} (FIG. 7) |
| (A20: Group Address) | | TM16: {A19, C19} (FIG. 7) |
| (A22: Broadcast Address) | TM17: {A20, C20) (FIG. 8) | TM18: {A21, C21} (FIG. 8) |
| | TM9: {A22, C22} (FIG. 9) | TM20: {A23, C23} (FIG. 9) |

YY* is a DALI command in the form an instruction or a query.

FIG. 7 illustrates a translation of individual address A1 by slave translator 21 into individually addressed translated messages TM11-TM13 in accordance with TABLE 1, and a transmission of individually addressed translated messages TM11-TM13 from slave translator 21 to slave devices 30-32. FIG. 7 further illustrates a translation of address A15 by slave translator 31 into individually addressed translated messages TM14-TM16 in accordance with TABLE 1, and a transmission of individually addressed translated messages TM14-TM16 from slave translator 31 to slave devices 40-42.

FIG. 8 illustrates a translation of group address A2 by slave translator 21 into a group addressed translated message TM17 in accordance with TABLE 1, and a transmission of group addressed translated message TM17 from slave translator 21 to slave devices 30 and 31. FIG. 8 further illustrates a translation of address A20 by slave translator 31 into group addressed translated message TM18 in accordance with TABLE 1, and a transmission of group addressed translated message TM18 from slave translator 31 to slave devices 40 and 41.

FIG. 9 illustrates a translation of broadcast address A3 by slave translator 21 into a broadcast addressed translated message TM19 in accordance with TABLE 1, and a transmission of broadcast addressed translated message TM19 from slave translator 21 to slave devices 30-32. FIG. 9 further illustrates a translation of address A22 by slave translator 31 into broadcast addressed translated message TM20 in accordance with TABLE 1, and a transmission of group addressed translated message TM20 from slave translator 31 to slave devices 40-42.

To facilitate an understanding of the default translation mode, FIG. 10 illustrates exemplary communications of various messages under the address translation mode in accordance with the following exemplary TABLE 3:

TABLE 3

| SLAVE | MASTER/TRANSLATED | TRANSLATED |
|---|---|---|
| TRANSLATOR | MESSAGE | MESSAGE |
| 21 | MM7: {XX*, YY**} | TM19: {A22, C22} |
| 31 | TM19: {A22, C22} | TM20: {A23, C23} |

XX* is either an individual DALI address, a group DALI address or a broadcast DALI address assigned to slave translator 21.
YY** is a DALI command in the form an instruction or a query.

FIG. 10 illustrates a translation of master message MM7 by slave translator 21 into a broadcast addressed translated message TM19 in accordance with TABLE 1, and a transmission of broadcast addressed translated message TM19 from slave translator 21 to slave devices 30-32. FIG. 10 further illustrates a translation of translated message TM19 by slave translator 31 into broadcast addressed translated message TM20 in accordance with TABLE 1, and a transmission of group addressed translated message TM20 from slave translator 31 to slave devices 40-42.

From the following description of FIGS. 4-10, those having ordinary skill in the art will appreciate how TABLES 1-3 can serve as a basis for programming look-up tables and/or conditional statements (e.g., IF-THEN-ELSE) within translation programs 28 and 38.

Referring to FIGS. 4-10, the various master messages and translated messages will either be in the form of a DALI instruction or a DALI query. FIG. 11 illustrates the communication of slave messages SM1-SM14 in the case where the master messages and the translated messages of FIGS. 4-10 are in the form of a DALI query asking “Are any lamp ballasts out?”. To facilitate an understanding of slave messages SM1-SM14, FIG. 11 illustrate exemplary communications of slave messages SM1-SM14 in accordance with the following exemplary TABLE 4:

TABLE 4

| SLAVE | RECEIVED | TRANSMITTED |
|---|---|---|
| TRANSLATOR | SLAVE MESSAGES | SLAVE MESSAGE |
| 31 | At least one of | SM9: {R9} (Positive) |
| | SM1: {R1} (Positive), | |
| | SM3: {R3} (Positive), and | |
| | SM5: {R5} (Positive) | |
| | within time period T1 | |
| | Two or less of | |
| | SM2: {R2} (Negative), | |
| | SM4: {R4} (Negative), and | |
| | SM6: {R6} (Negative) | |
| | within time period T1 | |
| | No slave messages | |
| | within time period T1 | |
| | All of | SM10: {R10} (Negative) |
| | SM2: {R2} (Negative), | |
| | SM4: {R4} (Negative), and | |
| | SM6: {R6} (Negative) | |
| | within time period T1 | |
| 21 | At least one of | SM13: {R13} (Positive) |
| | SM7: {R7} (Positive), | |
| | SM9: {R9} (Positive), and | |
| | SM11: {R11} (Positive) | |
| | within time period T2 | |
| | Two or less of | |
| | SM8: {R8} (Negative), | |
| | SM10: {R10} (Negative), | |
| | and SM12: {R12} | |
| | (Negative) within time | |
| | period T2 | |
| | No slave messages | |
| | within time period T2 | |
| | All of | SM14: {R14} (Negative) |
| | SM8: {R8} (Negative), | |
| | SM10: {R10} (Negative), | |
| | and SM12: {R12} | |
| | (Negative) within time | |
| | period T2 | |

Referring to FIG. 11, after sending a query to lighting devices 40-42, slave translator 31 awaits a time period T1 for a response from lighting devices 40-42. Slave translator 31 transmits a positive slave message SM9 (e.g., “A lamp is out”) to slave translator 21 upon a receipt of (1) any positive slave messages SM1, SM3 and SM5 (e.g., “My lamp is out”) during time period T1, (2) two or less negative slave messages SM2, SM4, and SM6 (e.g., “My lamp is operational”) within time period T1, or (3) a failure to receive any slave message within time period T1. Conversely, slave translator 31 transmits a negative slave message SM10 (e.g., “All lamps are operational”) to slave translator 21 upon a receipt of all of the negative slave messages SM2, SM4, and SM6 (e.g., “My lamp is operational”) within time period T1.

Similarly, after sending a query to slave devices 30-32, slave translator 21 awaits a time period T2 for a response from slave devices 30-32. Slave translator 21 transmits a positive slave message SM13 (e.g., “A lamp is out”) to master controller 10 upon a receipt of (1) any positive slave messages SM7, SM9 and SM11 (e.g., “My lamp is out”) during time period T2, (2) two or less negative slave messages SM8, SM10, and SM12 (e.g., “My lamp is operational”) within time period T2, or (3) a failure to receive any slave message within time period T1. Conversely, slave translator 21 transmits a negative slave message SM14 (e.g., “All lamps are operational”) to master controller 10 upon a receipt of all of the negative slave messages SM8, SM10, and SM12 (e.g., “My lamp is operational”) within time period T2.

Queries sent by slave translator 21 to slave devices 30-32 can either be in response to a reception of a query from master controller 10 or according to a programmed time table for transmitting queries. Similarly, queries sent by slave translator 31 to slave devices 40-42 can either be in response to a reception of a query from slave translator 21 or according to a programmed time table for transmitting queries to the corresponding slave devices. Whenever slave translator 21 queries slave devices 30-32 in response to a reception of a query from master controller 10, and slave translator 31 in turn queries slave devices 40-42 in response to the query from slave translator 21, time period T2 is sufficiently greater than time period T1 (e.g., T2>2T1) to enable slave translator 21 to interpret any received slave messages SM1-SM6 and to appropriately transmit slave message SM9 or SM10, and to enable slave translator 31 to interpret any received slave message SM7-SM12. Otherwise, time periods T1 and T2 are identical for query transmissions by slave translators 21 and 31 based on a programmed time table.

When transmitting queries to slave devices 30-32 based on a programmed time table, slave translator 21 will interpret any received slave messages SM7-SM12 and suspend a transmission of slave message SM13 or SM14, whichever is appropriate, until a receipt of a related query from master controller 10. Similarly, when transmitting queries to slave devices 40-42 based on a programmed time table, slave translator 31 will interpret any received slave messages SM1-SM6 and suspend a transmission of slave message SM9 or SM10, whichever is appropriate, until a receipt of a related query from slave translator 21.

FIG. 12 illustrates one unique programming feature of slave translator 21. Specifically, slave translator 21 transmits a translated message TM or a master message MM to slave devices 30-32 (e.g., “Go to light level xx”), and stores a current lighting level of lighting devices 30-32 based on the translated message TM or the master message MM. Slave translator 21 is programmed to generate a slave message SM15 including a reply R15 (e.g., “We are at light level xx”) that is responsive to a subsequent master message MM from master controller 10 of a power level query of lighting devices 30-32 (e.g, “What is your light level?”).

FIG. 13 illustrates one unique programming feature of slave translator 31. Specifically, slave translator 31 transmits a translated message TM or a master message MM to slave devices 40-42 (e.g., “Go to light level xx”), and stores a current lighting level of lighting devices 40-42 based on the translated message TM or the master message MM. Slave translator 31 is programmed to generate a slave message SM16 including a reply R16 (e.g., “We are at light level xx”) that is responsive to a subsequent translated message TM or master message MM from slave translator 21 of a power level query of lighting devices 40-42 (e.g, “What is your light level?”). In turn, slave translator 21 is programmed to generate a slave message SM15 including a reply R15 (e.g., “We are at light level xx”) that is responsive to a subsequent master message MM from master controller 10 of a power level query of lighting devices 30-32 (e.g, “What is your light level?”).

The descriptions of FIGS. 1-13 herein were provided to facilitate a simple explanation of the various principles of the present invention in communicating messages within a lighting system of the present invention. However, in practice, it may be impractical to implement a DALI lighting system of the present invention whenever sixty-four (64) or less lighting devices are employed in the DALI lighting system, such as, for example, the seven (7) lighting devices 20, 22, 30, 32, and 40-42 employed in the lighting system illustrated in FIG. 1. Nonetheless, those skilled in the art will appreciate how to use the various principles of the present invention as described with reference FIGS. 1-13 to make and operate a DALI lighting system of the present invention that employs at least one slave translator and sixty-five (65) or more lighting devices. FIGS. 15-19 illustrate some examples of such lighting systems.

FIGS. 14 and 15 illustrate a lighting system employing a conventional master controller (“MC”) 100 on a top network level. At an intermediate network level, the lighting system employs sixty-three (63) lighting devices (“LD”) conventionally connected to master controller 100, of which lighting devices 200-203 are shown, and a slave translator 263 conventionally connected to master controller 100. At a bottom network level, the lighting system employs sixty-four (64) lighting devices (“LD”) conventionally connected to slave translator 263, of which lighting devices 300-303 and 363 are shown. From the description of the lighting system illustrated in FIGS. 1-13, those having ordinary skill in the art will appreciate the various master message communication paths MM, translated message communication paths TM, and slave message communication path SM within the lighting system as illustrated in FIG. 15.

FIGS. 16 and 17 illustrate a lighting system employing conventional master controller (“MC”) 100 on a top network level. At one intermediate network level, the lighting system employs sixty-two (62) lighting devices (“LD”) conventionally connected to master controller 100, of which lighting devices 200-202 are shown, and a pair of slave translators 262 and 263 conventionally connected to master controller 100. At another intermediate network level, the lighting system employs sixty-two (62) lighting devices (“LD”) conventionally connected to slave translator 263, of which lighting devices 300 and 301 are shown, and a slave translator 364 conventionally connected to slave translator 263. At a bottom network level, the lighting system employs sixty-four (64) lighting devices (“LD”) conventionally connected to slave translator 264, of which lighting devices 400 and 463 are shown, and sixty-four (64) lighting devices (“LD”) conventionally connected to slave translator 364, of which lighting devices 500, 501 and 563 are shown. From the description of the lighting system illustrated in FIGS. 1-13, those having ordinary skill in the art will appreciate the various master message communication paths MM, translated message communication paths TM, and slave message communication path SM within the lighting system as illustrated in FIG. 17.

FIG. 18 illustrates a lighting system employing master controller 100 and five (5) local area networks 600, 700, 800, 900 and 1000. At an intermediate network level, local area network 600 employs a slave translator 601, local area network 700 employs a slave translator 701, local area network 800 employs a slave translator 801, local area network 900 employs a slave translator 901, and local area network 1000 employs a slave translator 1001. At a bottom network level, local area network 600 employs sixty-four (64) lighting devices 602-665, local area network 700 employs sixty-four (64) lighting devices 702-765, local area network 800 employs sixty-four (64) lighting devices 802-865, local area network 900 employs sixty-four (64) lighting devices 902-965, and local area network 1000 employs sixty-four (64) lighting devices 1002-1065. From the description of the lighting system illustrated in FIGS. 1-13, those having ordinary skill in the art will appreciate the various master message communication paths, translated message communication paths, and slave message communication path within the lighting system illustrated in FIG. 18.

While the embodiments of the present invention disclosed herein are presently considered to be preferred, various changes and modifications can be made without departing from the spirit and scope of the present invention. The scope of the invention is indicated in the appended claims, and all changes that come within the meaning and range of equivalents are intended to be embraced therein.

1. A lighting system of a plurality of network levels, said lighting system comprising:
a first slave translator (21) at a first network level;
a master controller (10) operable to transmit a master message (MM) to said first slave translator (21), the master message (MM) including a first address associated with the first network level and assigned to said first slave translator (21); and
a first slave device (30, 31) at a second network level,
wherein said first slave translator (21) is operable to translate the master message (MM) into a first translated message (TM) and to transmit the first translated message (TM) to said first slave device (30, 31), the first translated message (TM) including a second address associated with the second network level and assigned to said first slave device (30, 31).

2. The lighting system of claim 1,
wherein the master message (MM) further includes a first command;
wherein said first slave translator (21) utilizes the first command in translating the master message (MM) into the second address and a second command; and
wherein the first translated message (TM) includes the second address and the second command.

3. The lighting system of claim 1,
wherein said first slave translator (21) utilizes the first address in translating the master message (MM)into the second address and a second command; and
wherein the first translated message (TM) includes the second address and the second command.

4. The lighting system of claim 1,
wherein said first slave device is a lighting device (30); and
wherein the first translated message (TM) includes an instruction of operating said lighting device (30).

5. The lighting system of claim 1,
wherein said first slave device is a lighting device (30); and
wherein the first translated message (TM) includes a query of an operational status of said lighting device (30).

6. The lighting system of claim 1,
wherein said first slave device is a lighting device (30) operable to transmit a first slave message (SM) to said first slave translator (21), the first slave message (SM) being responsive to the first translated message (TM).

7. The lighting system of claim 6,
wherein said first slave translator (21) is further operable to transmit a second slave message (SM) to said master controller (10) at a third network level, the second slave message (SM) being based on the first slave message (SM).

8. The lighting system of claim 1, further comprising:
a second slave device (40) at a third network level,
wherein said first slave device is a second slave translator (31) operable to translate the first translated message (TM) into a second translated message (TM), and
wherein said second slave translator (31) is further operable to transmit the second translated message (TM) to said second slave device (40), the second translated message (TM) including a third address associated with the third network level and assigned to said second slave device (40).

9. The lighting system of claim 8,
wherein the first translated message (TM) further includes a first command;
wherein said second slave translator (31) utilizes the first command in translating the translated message (TM) into the third address and a second command; and
wherein the second translated message (TM) includes the third address and the second command.

10. The lighting system of claim 8,
wherein said second slave translator (31) translates utilizes the second address in translating the translated message (TM) third address and a second command; and
wherein the second translated message (TM) includes the third address and the second command.

11. The lighting system of claim 8,
wherein said second slave device is a lighting device (40); and
wherein the second translated message (TM) includes an instruction of operating said lighting device (40).

12. The lighting system of claim 8,
wherein said second slave device is a lighting device (40); and
wherein the second translated message (TM) includes a query of an operational status of said lighting device (40).

13. The lighting system of claim 8,
wherein said second slave device is a lighting device (40) operable to transmit a slave message (SM) to said second slave translator (31) at the second network level, the slave message (SM) being responsive to the second translated message (TM).

14. The lighting system of claim 13,
wherein said second slave translator (31) is further operable to transmit a second slave message (SM) to said first slave translator (21), the second slave message (SM) being based on the first slave message (SM); and
wherein said first slave translator (21) is further operable to transmit a third slave message (SM) to said master controller (10) at a fourth network level, the third slave message (SM) being based on the second slave message (SM).

16. A lighting system of a plurality of network levels, said lighting system comprising:
a first slave translator (21) at a first network level;
a second slave translator (31) at a second network level; and
a slave device (40) at a third network level,
wherein said first slave translator (21) is operable to transmit a master message (MM) to said second slave translator (31), the master message (MM) including a first address associated with the first network level and assigned to said second slave translator (31); and
wherein said second slave translator (31) is operable to translate the master message (MM) into a translated message (TM) and to transmit the translated message (TM) to said slave device (40), the translated message (TM) including a second address associated with the second network level and assigned to said slave device (40).

17. The lighting system of claim 16,
wherein the master message (MM) further includes a first command;
wherein said second slave translator (31) utilizes the first command in translating the master message (MM into the second address and a second command; and
wherein the translated message (TM) includes the second address and the second command.

18. The lighting system of claim 16,
wherein said second slave translator (31) translates utilizes the first address in translating the master message (MM into the second address and a second command; and
wherein the translated message (TM) includes the second address and the second command.

19. The lighting system of claim 16,
wherein said slave device is a lighting device (40); and
wherein the translated message (TM) includes an instruction of operating said lighting device (40).

20. The lighting system of claim 16,
wherein said slave device is a lighting device (40); and
wherein the translated message (TM) includes a query of an operational status of said lighting device (40).

21. The lighting system of claim 16, further comprising:
wherein said slave device (40) is operable to transmit a first slave message (SM) to said second slave translator (31);
wherein said second slave translator (31) is further operable to transmit a second slave message (SM) to said first slave translator (21), the second slave message (SM) being based on the first slave message (SM).

22. The lighting system of claim 21, further comprising:
a master controller (10) at a fourth network level;
wherein said first slave translator (21) is further operable to transmit a third slave message (SM) to said master controller (10), the third slave message (SM) being based on the second slave message (SM).

23. A lighting system of a plurality of network levels, said lighting system comprising:
a slave device (30, 31) at a first network level;
a first slave translator (21) at a second network level, wherein said first slave translator (21) is operable to transmit a master message (MM) to said slave device (30, 31), the master message (MM) including a first address associated with the first network level and assigned to said slave device (30, 31).
wherein said lighting device (30, 31) is operable to transmit a first slave message (SM) to said first slave translator (21) at a second network level, the slave message (SM) being responsive to the master message (MM); and
a master controller (10) at a third network level,
wherein said first slave translator (21) is further operable to transmit a second slave message (SM) to said master controller (10), the second slave message (SM) being based on the first slave message (SM).

24. A lighting system of a plurality of network levels, said lighting system comprising:
a slave device (40) at a first network level;
a first slave translator (31) at a second network level,
wherein said first slave translator (31 ) is operable to transmit a master message (MM) to said lighting device (40), the master message (MM including a first address associated with the first network level and assigned to lighting device (40), and
wherein said lighting device (40) is operable to transmit a slave message (SM) to said first slave translator (31) at a second network level, the slave message (SM) being responsive to the master message (MM); and
a second slave translator (21) at a third network level,
wherein said first slave translator (31) is further operable to transmit a second slave message (SM) to said second slave translator (21), the second slave message (SM) being based on the first slave message (SM).

25. The lighting system of claim 24, further comprising:
a master controller (10) at a fourth network level;
wherein said second slave translator (21) is further operable to transmit a third slave message (SM) to said master controller (10), the third slave message (SM) being based on the second slave message (SM).

26. A lighting system of a plurality of network levels, said lighting system comprising:
a slave device (30, 31) at a first network level;
a first slave translator (21) at a second network level, said first slave translator (21) operable to transmit a message (MM, TM) to said slave device, the message including a first address associated with the first network level and assigned to said slave device (30, 31); and
a master controller (10) operable to transmit a master message (MM) to said first slave translator (21), the master message (MM) including a second address associated with the second network level and assigned to said second slave translator (21),
wherein said first slave translator (21) is operable to transmit a slave message (SM) to said master controller (10), the slave message (SM) being based on the message (MM, TM) and responsive to the master message (MM).

27. A lighting system of a plurality of network levels, said lighting system comprising:
a slave device (40) at a first network level;
a first slave translator (31) at a second network level,
wherein said first slave translator (31) is operable to transmit a first message (MM, TM) to said slave device, the first message including a first address associated with the first network level and assigned to said slave device (40); and
a second slave translator (21) at a third network level,
wherein said second slave translator (21) is operable to transmit a second message (TM, MM) to said first slave translator (31), the second message (MM) including a second address associated with the second network level and assigned to said second slave translator (31), and
wherein said first slave translator (31) is further operable to transmit a first slave message (SM) to said second slave translator (21), the first slave message (SM) being based on the first message (MM, TM) and responsive to the second message (MM, TM).

28. The lighting system of claim 27, further comprising:
a master controller (10) at a fourth network level;
wherein said second slave translator (21) is further operable to transmit a third slave message (SM) to said master controller (10), the third slave message (SM) being based on the second message (MM, TM) and responsive to the master message (MM).
